(19) United States
(12) Patent Application Publication
(10) Pub. No.: US 2014/0038708 A1
(43) Pub. Date: Feb. 6, 2014

(54) VIRTUAL VIEWPOINT MANAGEMENT SYSTEM

(71) Applicants: John Davison, San Francisco, CA (US); Zachary Edson, El Macero, CA (US); Robyn Tas, Weston, CT (US); Boubou Guiro, Sausilito, CA (US); Simon Whitcombe, Rolavmo, CA (US)

(72) Inventors: John Davison, San Francisco, CA (US); Zachary Edson, El Macero, CA (US); Robyn Tas, Weston, CT (US); Boubou Guiro, Sausilito, CA (US); Simon Whitcombe, Rolavmo, CA (US)

(73) Assignee: CBS INTERACTIVE INC., San Francisco, CA (US)

(21) Appl. No.: 13/563,443

(22) Filed: Jul. 31, 2012

(51) Int. Cl. A63F 13/10

(52) U.S. Cl. CPC A63F 13/10
USPC 463/31

(57) ABSTRACT

A virtual viewpoint management system is described. An aspect provides for accessing video game information implemented in a video game application operating on a computing device; monitoring for one or more selection triggers; and presenting one or more virtual viewpoints on one or more display devices responsive to the one or more selection triggers, the one or more virtual viewpoints being presented according to the video game information during live game play of the video game application in substantially real-time. Other embodiments are described and claimed.

### BACKGROUND

Video game applications are designed to immerse players in a virtual environment that has become increasingly sophisticated and life-like. The high-quality animations of modern video games are a main reason why they now make up a major entertainment and media segment, a marketplace long dominated primarily by television, music, and movies. The perspectives and viewpoints experienced by players are a function of computer graphics components operating within the video game applications. A prominent computer graphics component is the virtual camera, particularly in three-dimensional (3D) games. In general, a virtual camera is a computer-generated version of a physical camera controlled to provide players with one or more perspectives during game play. A virtual camera receives geometric data for a set of parameters, such as position, aim, and field of view, and produces a viewpoint displayed to the video game player.

However, viewpoint capabilities of real-time game play are limited. For the most part, players are provided with only one viewpoint, such as a first-person or third-person viewpoint, or may access other views through cumbersome game controller manipulations that are difficult to carry out while playing the game, especially during intense game play. Additional perspectives may be accessed during non-live game play, but this does not benefit real-time action, where they may be most useful to players, spectators, or developers.

### BRIEF DESCRIPTION OF THE DRAWINGS

FIG. 1 illustrates an embodiment of a virtual viewpoint management system.

FIG. 2 illustrates an embodiment of a first operating environment for a virtual viewpoint application.

FIGS. 3A-3G illustrate an embodiment of a second operating environment for a virtual viewpoint application.

FIGS. 4A-4D illustrate an embodiment of a third operating environment for a virtual viewpoint application.

FIG. 5 illustrates an embodiment of a fourth operating environment for a virtual viewpoint application.

FIG. 6 illustrates an embodiment of a first logic flow.

FIG. 7 illustrates an embodiment of a second logic flow.

FIG. 8 illustrates an embodiment of a computing architecture.

FIG. 9 illustrates an embodiment of a communications architecture.

### DETAILED DESCRIPTION

Video game consumers have always expected substantive improvements in graphics and animations with each new video game application release, regardless of whether it is a new game or the next generation of a well-known franchise. These expectations are now carrying over into other facets of the game, such as multiplayer capabilities, story lines, characters, technical and game play support, cheats, and the overall immersive experience provided through the virtual game environment. The same demands are now being realized by game developers, manufacturers, and content providers, such as GameSpot®, an online news and information content provider dedicated to covering video games and the gaming industry.

During active game play, the user is presented with a user interface that serves as a window into the game virtual environment. Although there may be action occurring elsewhere throughout the game, such as in multiplayer games and massively multiplayer online games (MMOs or MMOGs) like World of Warcraft® and Call of Duty®, the user may only see the action displayed through the user interface. The user interface presents the user with a particular perspective into the virtual environment, such as a first-person, third-person, or top-down perspective (e.g., overhead or birds-eye view). These perspectives may limit the amount of game action that a player may see and restricts the available perspectives for viewing game play.

Existing technology provides for a few user interface capabilities under certain circumstances. In one implementation, users may view other perspectives or viewpoints after the live action has taken place, in the manner of an “instant replay.” However, this does not benefit the perception of live game play as users may only see past events. In another implementation, users may have a certain amount of control over the field of view, for example, switching from a first-person perspective to a third-person perspective or controlling the location of a floating camera, via one or more game controller operations. Nonetheless, in practice, this is often cumbersome and difficult to carry out effectively during live gameplay scenarios, particularly during intense game play, when it may be most beneficial.

Along with game players, other interested parties may benefit from the availability of enhanced game play viewpoints, including developers, content publishers, and spectators. Developers may be able to better troubleshoot, support, and develop future video game applications if they are better able to fully appreciate a wider arrangement of viewpoints occurring during live gameplay. For example, if a developer could see additional views of virtual game character interactions, they may be better able to provide point-of-view (POV) support content and utilize an additional dimension for comprehending how all of the moving parts of the game interact. In a similar manner, content providers, such as third-party content providers, could benefit and provide more detailed and accurate commentary and guides for video game applications. For instance, by being able to provide an explanation of virtual game elements that may not be seen based on a first-person perspective in a first-person shooter (FPS) game.

A recent and rapidly advancing phenomenon is electronic sports (e-sports), which involves the competitive playing of video games. Although e-sports involve a large number of game players, they also involve a number of spectators, whose numbers often greatly outnumber the actual players. Spectators may watch the live game play at the site of the e-sport competition or through alternative media experiences, such as through online portals streaming the game play animations, which may be accessible via a web browser application over the Internet.

During game play, a large amount of time is spent by the virtual characters moving through the virtual environment figuring out where to go and where to locate certain items or other characters. These scenes may not be very appealing to spectators. As such, e-sports may benefit from viewpoint control that automatically and continuously locates game play action of interest (e.g., shooting, fighting, direct character interaction, change in character health or other such characteristics) for presentation to spectators.

For a live sporting event, such as Major League Baseball® (MLB®), there are multiple physical cameras controlled by camera persons that may provide television viewers with multiple angles of a base hit. As such, a television viewer may see the base hit from the perspective of the batter, the pitcher, outfielders, a top-down view, fans, and combinations thereof. However, video game engines and graphics components are comprised of programming code that is not human operated. In addition, computer games are much less predictable as there are a vast number of scenarios that may play out for any given video game segment. As such, video game applications, and e-sports in particular, may benefit from techniques that provide multiple perspectives for a single game play event, such as a fight or other character interaction.

Accordingly, various embodiments are generally directed to managing viewpoints in a virtual environment generated by a video game application. Some embodiments are particularly directed to providing multiple viewpoints for a particular video game event. In one embodiment, viewpoints are presented to users based on one or more triggers, such as user selection, video game activity rising above a threshold amount, or the occurrence of a particular video game event. In this manner, a number of different types of viewpoints may be configured for presentation responsive to certain actions within the game. As such, game players, developers, and spectators may benefit by having access to additional dimensions of a particular game not available according to existing technology, thereby enhancing user and spectator experience, the availability of information, and video game advancement.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

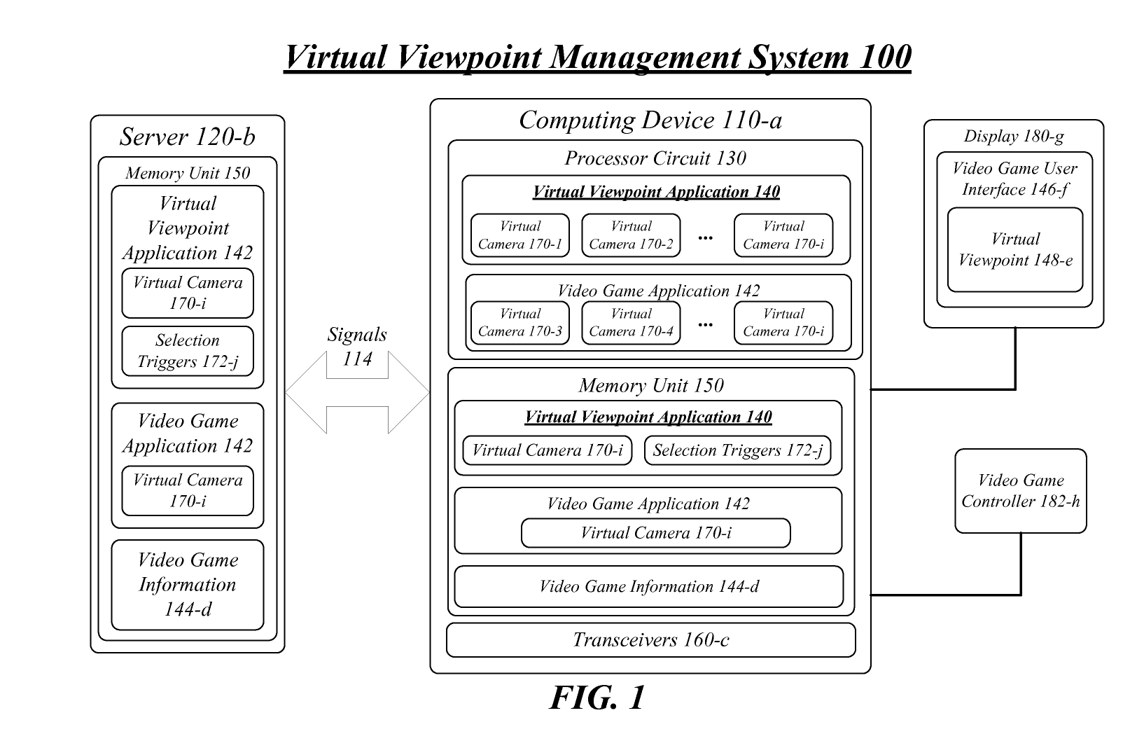

FIG. 1 illustrates a block diagram for a virtual viewpoint management system 100. In one embodiment, the virtual viewpoint management system 100 may comprise a computer-based system comprising a computing device 110-a. The computing device 110-a may comprise, for example, a processor circuit 130, a memory unit 150, and one or more transceivers 160-c. The computing device 110-a may further have installed a virtual viewpoint application 140. The memory unit 150 may store an unexecuted version of the virtual viewpoint application 140. Although the virtual viewpoint management system 100 shown in FIG. 1 has a limited number of elements in a certain topology, it may be appreciated that the virtual viewpoint management system 100 may include more or less elements in alternate topologies as desired for a given implementation.

It is worthy to note that “a,” “b,” “c” and similar designators as used herein are intended to be variables representing any positive integer. Thus, for example, if an implementation sets a value for a=3, then a complete set of computing devices 110-a may include computing devices 110-1, 110-2, and 110-3. The embodiments are not limited in this context.

In various embodiments, the virtual viewpoint management system 100 may comprise multiple computing devices, such as computing devices 110-a and servers 120-b. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a video game console computing device (e.g., Nintendo Wii®, Sony PlayStation®, Microsoft Xbox®), a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, computing device 110-a and server 120-b may be implemented as a PC and a network server, respectively, accessible over a network, such as the Internet. In an alternative embodiment, the computing device 110-a may be implemented as a desktop computer, video game console computing device, or a mobile device having a portable power supply and wireless communications capabilities, such as a laptop computer, handheld computer, tablet computer, smart phone, gaming device, consumer electronic, or other mobile device. The embodiments are not limited to these examples, however, and any computing devices 110-a or servers 120-b may be used as desired for a given implementation. The computing devices 110-a may communicate with other computing devices 120-b using communications signals 112 via the transceivers 160-c. The embodiments are not limited in this context.

In various embodiments, the virtual viewpoint management system 100 may comprise a processor circuit 130. The processing circuit 130 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processing circuit 130.

In various embodiments, the virtual viewpoint management system 100 may comprise a memory unit 150. The memory unit 150 may store, among other types of information, the virtual viewpoint application 140 and a video game application 142. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

In various embodiments, the computing devices 110-a may comprise one or more transceivers 160-c. Each of the transceivers 160-c may be implemented as wired transceivers, wireless transceivers, or a combination of both. In some embodiments, the transceivers 160-c may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 160-c may comprise or implement various communication techniques and communication signals 112 to allow the computing devices 110-a to communicate with other electronic devices, such as the servers 120-b. For instance, the transceivers 160-c may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the computing devices 110-a may implement different types of transceivers 160-c. Each of the transceivers 160-c may implement or utilize a same or different set of communication parameters to communicate information between various electronic devices. In one embodiment, for example, each of the transceivers 160-c may implement or utilize a different set of communication parameters to communicate information between the computing devices 110-a and one or more remote devices, such as remote servers 120-b. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 160-c. The embodiments are not limited in this context.

In one embodiment, for example, the transceiver 160-c may comprise a radio designed to communicate information over a wireless local area network (WLAN), a wireless metropolitan area network (WMAN), a wireless wide area network (WWAN), or a cellular radiotelephone system. The transceiver 160-c may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 160-c may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

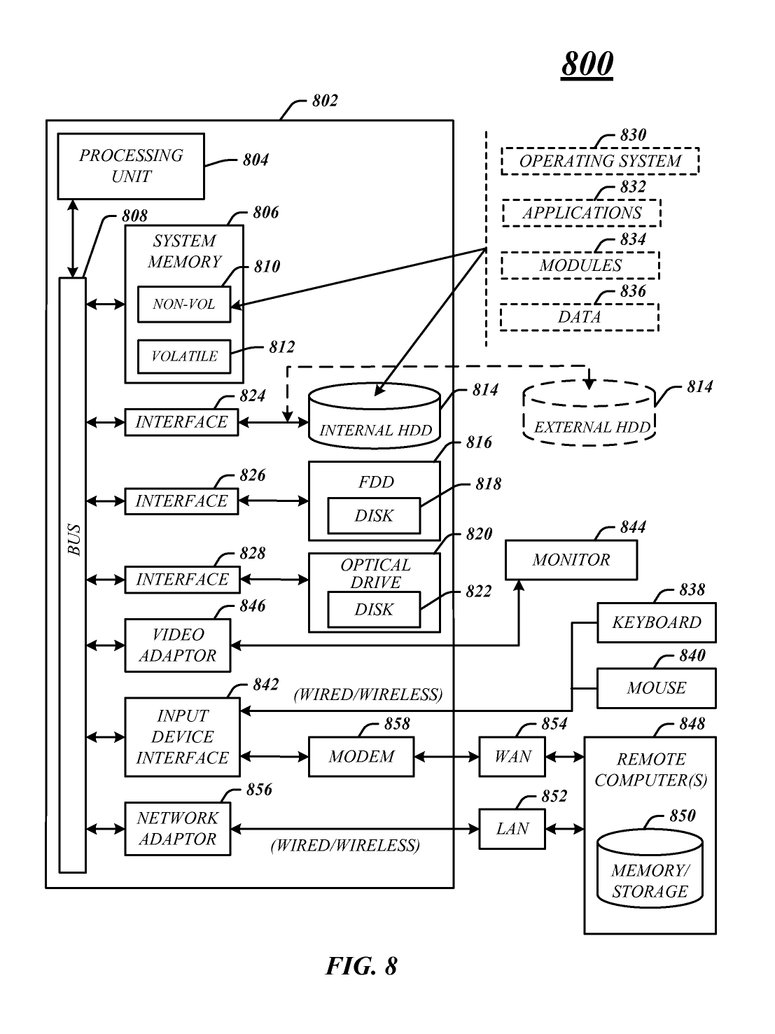

Although not shown, the computing devices 110-a and servers 120-b may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 8. The embodiments, however, are not limited to these examples.

In the illustrated embodiment shown in FIG. 1, the processor circuit 130 may be communicatively coupled to the transceiver 160-c and the memory unit 150. The memory unit 150 may store a virtual viewpoint application 140 arranged for execution by the processor circuit 130 to manage virtual viewpoints 148-e presented by a video game user interface 146-f on a display 180-g, which may be connected to the computing device 110-a. The servers 120-b may implement similar elements as the computing devices 110-a, including a processor circuit 130, a memory unit 150, and transceivers 160-c. For example, servers 120-b may be comprised of a memory unit 150 storing a video game application 142 and video game information 144-d.

The video game application 142 may operate on a computing device 110-a, on a server 120-b accessible by the computing device 110-a, or some combination thereof. For example, the computing device 110-a may operate a client version of the video game application 142 fully operational when in communication with the full video game application 142 operating on the server 120-b connected, for example, over the Internet. In another example, the computing device 110-a may access a full version of the video game application in a memory unit 150 of the computing device 110-a, such as a executable video game application 142 stored on a computing device 110-a data store (e.g., hard drive) or a video game application 142 stored on a computer-readable medium (e.g., DVD or video game cartridge) and accessible by the computing device 110-a. The embodiments, however, are not limited to these examples.

The video game application 142 may have one or more programming modules configured to provide a video game user interface 146-f comprised of one or more virtual viewpoints 148-e. The video game user interface 146-f displays virtual viewpoints 148-e as well as other information, such as menu information, game statistics, and other visual graphics visible (e.g., player health, multiplayer information, ammunition, etc.) on the display 180-g regardless of the virtual viewpoint 148-e. In the example embodiment of FIG. 1, the programming modules are configured as virtual cameras 170-i. In general, a virtual camera 170-i may be configured to simulate the operations of a physical camera within a virtual environment generated by the video game application 142 and to generate animations for display to a user through the video game interface 146-f. The virtual camera 170-i may utilize video game information 144-d to generate video game animations. According to embodiments, the video game information 144-d may include, but is not limited to, virtual environment data relating to landscape and game element information (e.g., buildings, characters, weapons, vehicles, geography, topography, coordinates), telemetry data (e.g., record of events in a game, character position and movement data), game character data, game settings, statistics, field of view, and other information utilized during operation of the video game application. For example, a virtual camera 170-i may access landscape and game element information to generate animations depicting the background (e.g., land, buildings, vehicles, etc.) and game character and telemetry data to generate animations showing interaction among two game characters. The virtual camera 170-i may operate to continuously update the animations, for example, if a building is destroyed or a character leaves the field of view.

The video game application 142 may be comprised of multiple virtual cameras 170-i configured to operate in one or more modes or areas of the virtual environment. According to embodiments, certain programming constructs or modules of the video game application 142, such as the virtual cameras 170-i may be accessible to one or more external programs (i.e., virtual viewpoint application 140), such as through an application programming interface (API). In this manner, the virtual cameras 170-i, video game information 144-d, and other video game application 142 features may be accessed and controlled by external programs, such as the virtual viewpoint application 140.

One or more video game controllers 182-h may be coupled to the computing device 110-a operating as input devices configured to operate the video game application 142. The video game controllers 182-h may be in any form known to those having ordinary skill in the art, including, a mouse, keyboard, or any other type of proprietary video game controller 182-h configured to operate with a specific gaming system (e.g., Nintendo Wii®, Sony PlayStation®, Microsoft Xbox®).

The computing device 110-a may be coupled with one or more displays 180-g capable of displaying a video game user interface 146-f resulting from operation of the video game application 142. The display 180-g may comprise any digital display device suitable for the computing device 110-a. For instance, the display 180-g may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying a video game user interface 146-f to a user of the computing device 110-a. The display 180-g may further include some form of a backlight or brightness emitter as desired for a given implementation.

The virtual viewpoint application 140 may generally provide features to manage virtual viewpoints 148-e during game play of a video game application 142. The virtual viewpoints 148-e may be comprised of viewpoints or perspectives of animations generated by the video game application 142 for display on the display 180-g. According to embodiments, virtual viewpoints 148-e may include, but are not limited to, a first-person perspective, a second-person perspective, a third-person perspective, a player-object top-down perspective (e.g., a birds-eye view following a particular character), a virtual environment top-down perspective (e.g., a birds-eye view of the virtual environment at one or more levels of detail, generating a map view of the virtual environment), and a virtual environment activity top-down perspective (a map view of the virtual environment displaying or highlighting areas of activity within the virtual environment; a “heat map”).

Embodiments provide for the dynamic display of virtual viewpoints 148-e based on one or more factors in the form of, for example, one or more selection triggers 172-j. Depending on the number and configuration of the displays 180-g, one or more virtual viewpoints 148-e may be simultaneously displayed on multiple displays 180-g, on one display 180-g, or some combination thereof. The selection triggers 172-j may be comprised of any factor capable of signaling to the virtual viewpoint application to display one or more virtual viewpoints 148-e, for example, responsive to a user selection or a predefined criteria, such as the occurrence of a specific event or a threshold level of activity. According to embodiments, the selection triggers 172-j may be configured in the virtual viewpoint application 140, for example, through a menu selection system.

The computing device 110-a may operate entirely separate from a server 120-b, operating a full version of the virtual viewpoint application 140 and video game application 142, and maintaining the video game information 144-d locally. Embodiments provide for alternative configurations, for example, the computing device 110-a may operate the video game application 142 and maintain video game information 144-d locally, and the virtual viewpoint application may operate on the server 120-b, communicating with the computing device 110-a and the video game application 142 operating thereon through communication signals 112. The embodiments are not limited in this context.

The virtual viewpoint application 140 may be external to the video game application 142 (i.e., a “stand-alone” embodiment), accessing the video game application 142 and video game information 144-d for managing the virtual viewpoints 148-e presented on the display 180-g. For instance, the virtual viewpoint application may access the video game application 142, the video game information 144-d, a video game engine for the video game application 142, or some combination thereof, for example, through one or more APIs, and may be configured to output video signals comprising animations for the video game application. In one embodiment, the virtual viewpoint application may generate and output its own video signals to produce virtual viewpoints 148-e for the video game application 142. In another embodiment, the virtual viewpoint application 140 may generate instructions for the video game application 142 or video game engine thereof to output certain virtual viewpoints 148-e to the display 180-g. In this manner, the virtual viewpoint application 140 may operate as a stand-alone application, an add-on, an external programming module, or some other external executable application capable of generating animations for one or more video game applications 140. Alternatively, the virtual viewpoint application 140 may be a programming module or other programming construct within the video game application 142 (i.e., an “internal” embodiment), either programmed or configured by the original developer or arranged within the video game application 142 as part of an update or revision to the original video game application 142.

In either a stand-alone or internal embodiment, the virtual viewpoint application 140 may be configured to generate virtual viewpoints 148-e utilizing virtual cameras 170-i internal to the virtual viewpoint application 140 or utilizing virtual cameras 170-i operating within the video game application 142. As such, the virtual viewpoint application 140 may access video game information 144-d and the video game application 142 (e.g., internal data, programming constructs, parameters, etc.) and may utilize these components to control virtual cameras 170-i within the video game application 142. Alternatively, the virtual viewpoint application 140 may access the video game information 144-d and the video game application 142 as source data to operate internal virtual cameras 170-i configured to generate and output virtual viewpoints 148-e.

The animations may be output to a display 180-g accessible to the computing device 110-a. The video game user interface 146-f may entirely or partially consist of the animations controlled by the virtual viewpoint application 140. In one embodiment, the virtual viewpoint application 140 may be configured to broadcast the animations in the form of virtual viewpoints 148-e. For example, users may access a web site streaming the virtual viewpoints 148-e generated by the virtual viewpoint application 140, for example, to watch an e-sports event broadcast over the Internet. The web site may be accessed by a thin-client application and any associated thin-client hardware, including, but not limited to, ultra-thin client, web thin client, and mobile thin client implementations, or through a web browser user interface, including without limitation Microsoft® Internet Explorer®, Mozilla® Firefox®, Apple® Safari®, and Google Chrome™ browser applications.

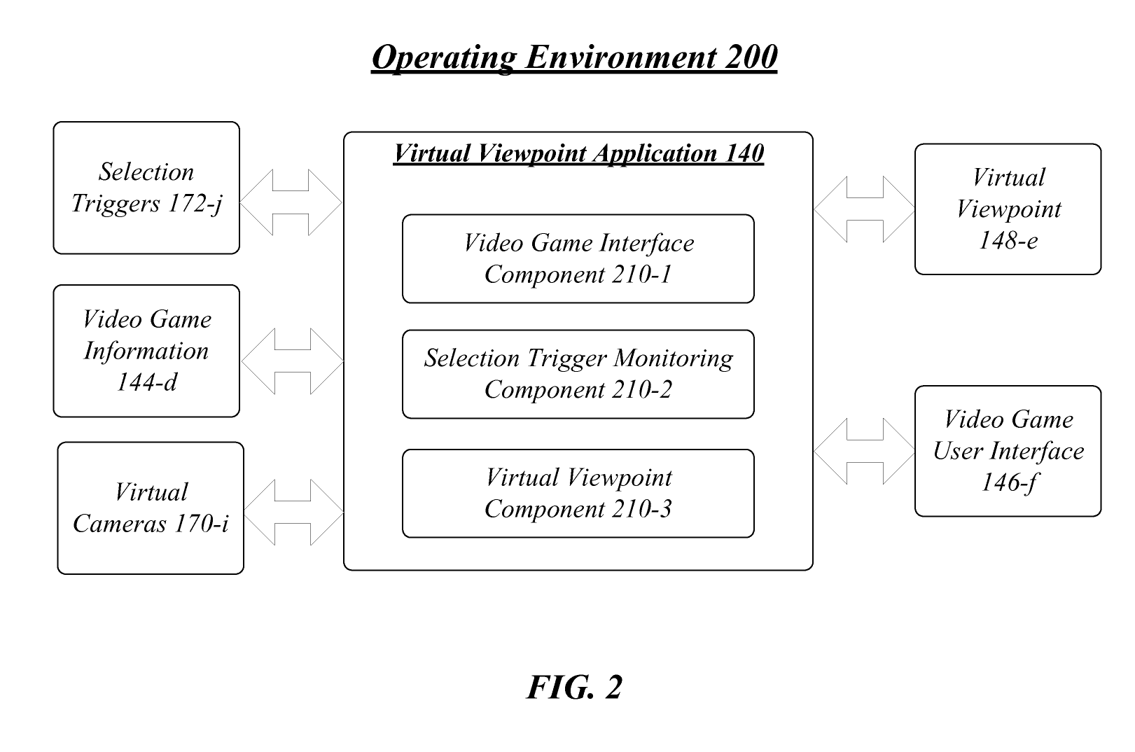

Particular aspects, embodiments and alternatives of the virtual viewpoint management system 100 and the virtual viewpoint application 140 may be further described with reference to FIG. 2.

FIG. 2 illustrates an embodiment of an operating environment 200 for the virtual viewpoint management system 100. More particularly, the operating environment 200 may illustrate a more detailed block diagram for the virtual viewpoint application 140.

As shown in FIG. 2, the virtual viewpoint application 140 may comprise various components 210-k. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the virtual viewpoint application 140 may comprise a video game interface component 210-1, a selection trigger monitoring component 210-2, and a virtual viewpoint component 222-3. Although the virtual viewpoint application 140 shown in FIG. 2 has only three components in a certain topology, it may be appreciated that the virtual viewpoint application 140 may include more or less components in alternate topologies as desired for a given implementation. The embodiments are not limited in this context.

The video game interface component 210-1 may generally access video game information 144-d associated with the video game application 142. According to embodiments, the video game information 144-d may be comprised of any information related to operation of the video game application 142, particularly information that may be utilized by the virtual viewpoint application 140 to generate virtual viewpoints 148-e or to control a virtual camera 170-i. Illustrative and non-restrictive examples of video game information 144-d include telemetry data, historical data, parameters, settings, variables, variable values, version and build information, user information, virtual environment data, character data, animation data, and graphics components and associated data. The video game interface component 210-1 may interface with the video game application 142 as a module or programming construct of the video game application configured to have access to video game information 144-d. In one embodiment the virtual viewpoint application 140 may be external to the video game application, as a standalone application, module, or engine, and the video game interface component 210-1 may access video game information 144-d of the video game application 142 through one or more methods known to those having ordinary skill in the art, such as through one or more APIs. The video game interface component 210-1 may access the video game information 144-d on an as-needed basis, or it may retrieve some or all of the video game information 144-d and update as required. The video game information 144-d accessed by the video game interface component 210-1 may be generally available within the virtual viewpoint application 140.

The selection trigger monitoring component 210-2 may generally monitor for the occurrence of one or more selection triggers 172-j configured to trigger the generation of one or more virtual viewpoints 148-e. According to embodiments, the selection triggers 172-j may be associated with one or more virtual viewpoints 148-e and may be configured to notify the virtual viewpoint application 140 to generate or display one or more of the associated virtual viewpoints 148-e. As such, embodiments provide that the virtual viewpoint application 140 may provide for one or more parameters or settings for users to configure selection triggers 172-j and virtual viewpoints 148-e associated therewith. For example, a selection trigger 172-j may be the selection of one or more buttons on a video game controller 182-h (e.g., keyboard, mouse, proprietary video game controller). In one embodiment, the video game controller 182-h may be a controller utilized by a user engaged in active game play with the video game application 142. In another embodiment, the video game controller 182-h may be coupled with a computing device 110-a configured to control the display of one or more virtual viewpoints 148-e to players or spectators. As such, embodiments provide that the virtual viewpoint application 140 may be utilized to provide a computing device 110-a focused on displaying virtual viewpoints 148-e of interest, in addition to or separate from being focused on actually playing the video game application 142.

Selection triggers 172-j may be comprised of any signal, setting, event, or threshold capable of communicating to the virtual viewpoint application 140 to display one or more virtual viewpoints 148-e. Exemplary selection triggers 172-j include, but are not limited to, manual selection, detection of the occurrence of one or more events internal or external to the video game application 142 game play, detection of activity, such as certain types of activity, certain levels of activity, obstructed character views, or combinations thereof.

Manual selection may include selection via a video game controller 182-h or other input device wherein a user makes a selection of the virtual viewpoints 148-e, such as from a menu or by configuring one or more parameters. Embodiments may also provide top-level virtual environment viewpoints 148-e that may serve as a map of the virtual environment. The top-level virtual environment viewpoints 148-e may be augmented to show the level of activity within the virtual environment (a “heat map”). As such, a user may select to view a top-level virtual environment viewpoint 148-e or heat map 148-e, and may make manual selections thereon, invoking the display of corresponding virtual viewpoints 148-e.

An internal event may comprise any detectable event within the video game application 142 during live game play, such as fighting, shooting, fire, collisions, explosions, player interaction, death, injury, change in a player characteristic (e.g., health, weapons, category), the engagement of characters with particular rankings (e.g., two high ranking characters interacting, or a low ranked character defeating a high ranking character), characters reaching one or more areas in the virtual environment, or characters achieving a certain level within the game. An external event may be detectable interest in or popularity of one or more viewpoints. For example, if the selection trigger monitoring component 210-2 detects that a certain number of players or spectators are interested in a certain viewpoint (e.g., based on the number of views at spectator web browsers or manual selection at spectator computing devices 110-a), this may be detected as a selection trigger 172-j to display the certain viewpoint as one of the virtual viewpoints 148-e.

The obstruction of a player view may act as a selection trigger 172-j such that a player or spectator may see any activity occurring behind an obstruction. For example, in a FPS video game application 142, the player may arrive at an obstruction (e.g., wall, building) that may block the view of a character on the other side of the obstruction. A selection trigger 172-j may be configured whenever the FPS character reaches an obstruction, or an obstruction with certain activity or game elements on the other side, invoking a virtual viewpoint 148-e that automatically and dynamically allows the player, spectators, or developers to see what is occurring on the other side of the obstruction.

The level of game activity may be utilized as a selection trigger 172-j such that a virtual viewpoint 148-a may be displayed for game activity above a certain threshold. In addition, certain types of activity may form a selection trigger 172-j, such as activity in certain areas within the virtual environment or a character locating a certain element (e.g., an important game element that is part of the structure of succeeding within the game). For example, the virtual viewpoint application 140 or the video game application 142 may be comprised of one or more modules capable of tracking character activity, such as tracking the firing of weaponry, fighting engagement, explosions, or collisions. The activity may be quantified (e.g., number of weapons being fired, number of rounds fired per amount of time, number of characters affected by the weapons, number of characters involved in the activity, ranking or score of engaged characters) and thresholds established. As such, when the threshold is reached (e.g., more than three users are engaged, or a character associated with a particular ranking, weapon, level, or game element is involved in a particular activity), then one or more specified virtual viewpoints 148-e may be displayed. For example, an embodiment may provide that whenever more than three characters are involved in a fight comprising the firing of weaponry, a first-person perspective of the character with the highest ranking is displayed, a top-down viewpoint is displayed, both are displayed, or some combination thereof.

The virtual viewpoint component 210-3 may generally operate to present virtual viewpoints 148-e responsive to the selection triggers 172-j. The virtual viewpoints 148-e are based on the video game information 144-d, for example, as generated during live game play of the video game application. As described hereinabove, the virtual viewpoint component 210-3 may utilize the video game information 144-d and its own virtual cameras 170-i or the virtual cameras 170-i of the video game application to generate the virtual viewpoints 148-e in substantially real-time. In one embodiment, the virtual viewpoint component 210-3 may communicate with and control a video game application 142 virtual camera 170-i, activating the virtual camera 170-i, if necessary, and feeding the virtual camera 170-i the video game information 144-d to render a virtual viewpoint. In another embodiment, the virtual viewpoint component 210-3 may utilize the video game information 144-d accessed by the video game interface component 220-1 to control internal virtual cameras 170-i for the generation and output of virtual viewpoints 148-e in the video game user interface 146-f.

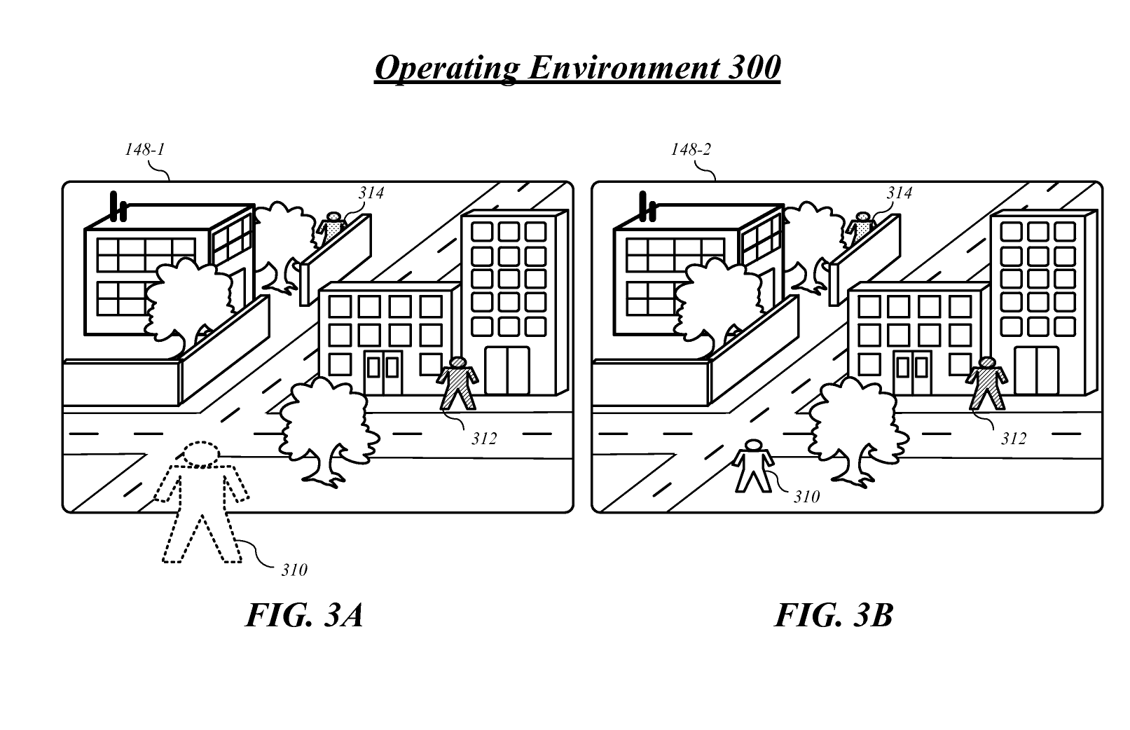

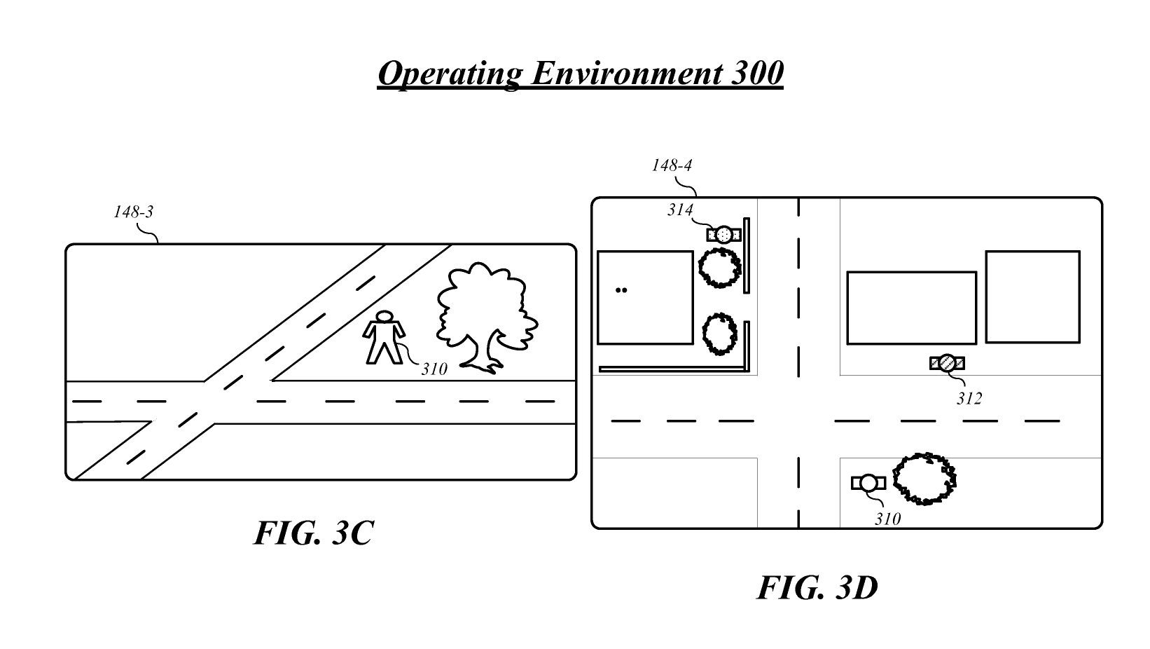

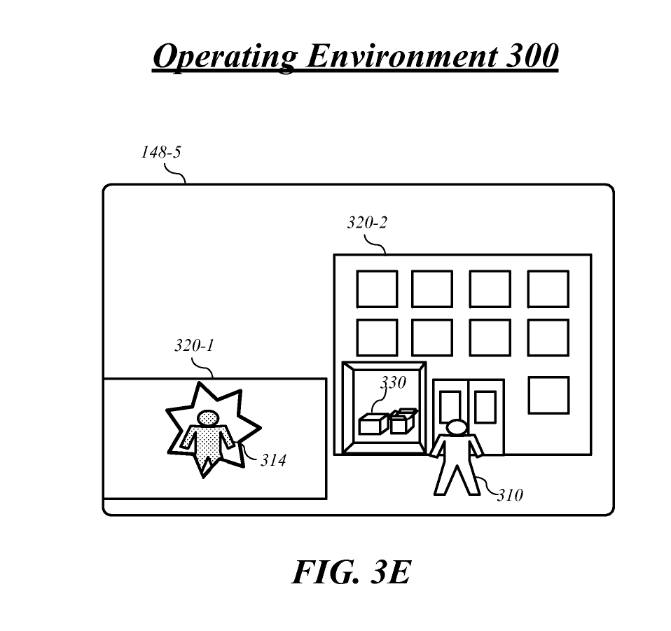

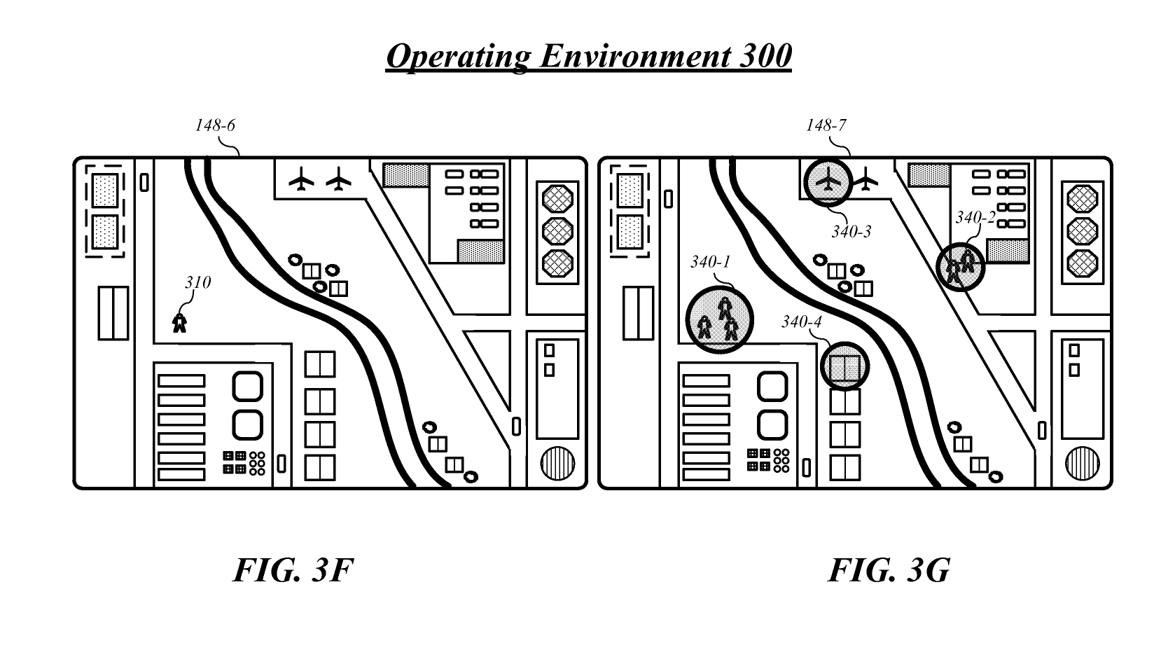

Particular aspects, embodiments and alternatives of the virtual viewpoint management system 100 and the virtual viewpoint application 140 may be further described with reference to FIG. 3.

FIGS. 3A-3G illustrate an embodiment of an operating environment 300 for the virtual viewpoint management system 100. More particularly, the operating environment 300 may illustrate virtual viewpoints 148-e that may be presented by the virtual viewpoint application 140 according to embodiments. FIGS. 3A-3G are non-restrictive examples as embodiments are not limited to only those viewpoints illustrated therein.

In FIG. 3A, therein is provided a first-person virtual viewpoint 148-1 from the viewpoint of a first character 310 (i.e., the main character, protagonist, or the character of the player involved in the game play at the particular computing device 110-a), showing various game elements, a second character 312, and a third character 314. The virtual viewpoint 148-1 is generated from the perspective of the first character 310, who is not visible in the virtual viewpoint 148-1, as indicated by the broken lines. FIG. 3B depicts a third-person virtual viewpoint 148-2. In this viewpoint, the first character 310, the second character 312, and the third character 314 are viewed from the standpoint of a virtual camera 170-i that may capture all of the characters 310, 312, 314, but is not visible itself. Referring to FIG. 3C, therein is provided a second-person virtual viewpoint 148-3, wherein the perspective is from the second character 312 who is active in the game play with the first character 310 (i.e., the main character). FIG. 3D provides a top-down virtual viewpoint 148-4 comprising an overhead view of characters 310, 312, 314 located in the scene provided in FIGS. 3A-3B. A top-down virtual viewpoint 148-4 may be focused on a particular object or player (i.e., a player object overhead view) or may be a general top-down view for a particular area (i.e., a top-down perspective).

FIG. 3E demonstrates a virtual viewpoint 148-5 invoked when the view of a character 310 is obstructed by one or more obstructions 320-1, 320-2. As shown in FIG. 3E, characters 314 or game objects 330 behind obstructions 320-1, 320-2 may be displayed in virtual viewpoint 148-5 responsive to a view obstruction. In addition to the “see-through” examples shown in FIG. 3E, alternative virtual viewpoints 148-e may be provided that present a perspective on the other side of an obstruction. Referring to FIG. 3F, therein is provided a virtual environment overhead virtual viewpoint 148-6, which provides a high-level view of the virtual environment for a video game application 142 from a map-like perspective. According to embodiments, certain game objects may be indicated in the virtual viewpoint 148-6 which are of importance, are important and may not be visible otherwise, or both, such as the first character 310. FIG. 3G provides the same perspective of FIG. 3F, augmented to provide a virtual environment activity overhead virtual viewpoint 148-7 (i.e. “heat map”). In the example embodiment of FIG. 3G, the virtual viewpoint 148-7 highlights “hotspots” 340-m, such as areas of activity 340-1, 340-2 (e.g., areas demonstrating a threshold level of activity) and importance 340-3, 340-4 (e.g., strategic areas, or areas where certain game objects are located).

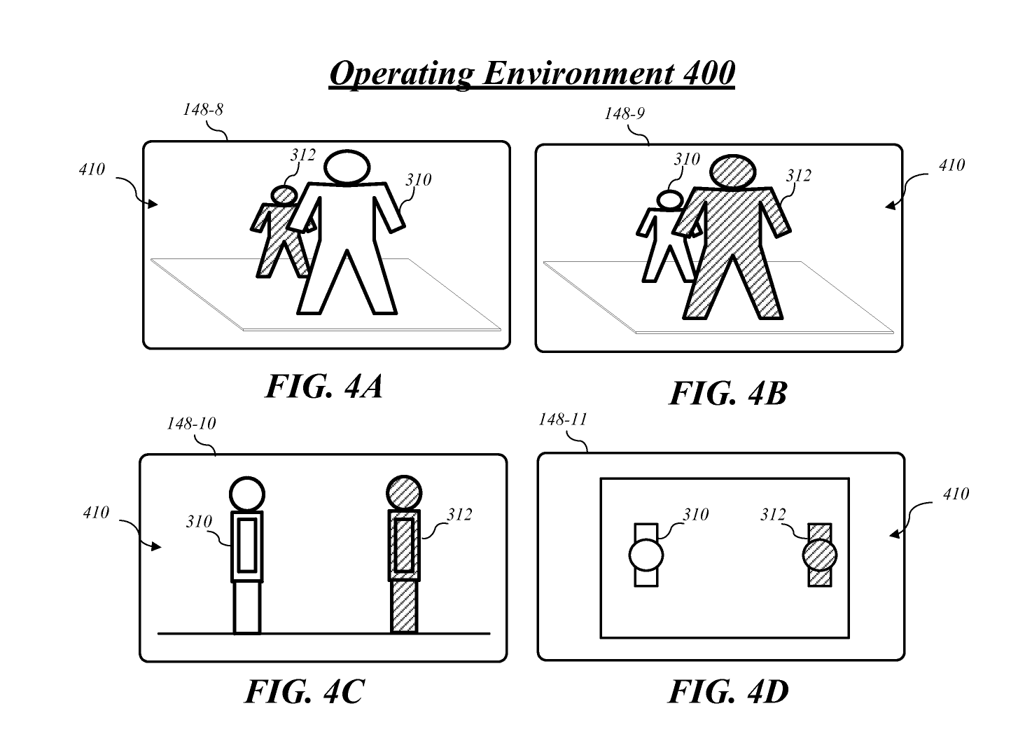

According to embodiments, multiple virtual viewpoints 148-e may be displayed for an event. For example, in a fighting event, multiple virtual viewpoints 148-e may be dynamically and automatically presented to provide multiple perspectives to users, developers, and spectators. FIGS. 4A-4D illustrate an embodiment of an operating environment 400 for the virtual viewpoint management system 100. More particularly, the operating environment 400 may illustrate multiple viewpoints provided according to an example embodiment.

The same event 410 is depicted in FIGS. 4A-4D, which, in these examples, involves interaction between two characters 310, 312. FIG. 4A provides a virtual viewpoint 148-8 with the first character 310 in the foreground facing the second character 312 in the background. In FIG. 4B, the virtual viewpoint 148-9 is from a perspective opposite of FIG. 4A, wherein the second character 312 is in the foreground facing the first character 310, who is in the background. FIG. 4C provides a virtual viewpoint 148-10 depicting the event 410 involving the first character 310 and the second character 212 from a side perspective, while FIG. 4D provides a virtual viewpoint depicting the event 410 involving the first character 310 and the second character 212 from an overhead perspective. As shown in FIGS. 4A-4D, multiple virtual viewpoints 148-8, 148-9, 148-10, 148-11, 148-e may be provided to present more than one perspective to an event 410. According to embodiments, the multiple virtual viewpoints 148-8, 148-9, 148-10, 148-11 may be displayed simultaneously in substantially real-time as live gameplay, either on one screen (e.g., through a multi- or split-screen configuration) or separately or in combination on multiple screens. As such, embodiments provide for the presentation of game play to players, developers, and spectators in a manner now provided for live sporting (e.g., MLB®) and entertainment events broadcasting feeds from physical cameras.

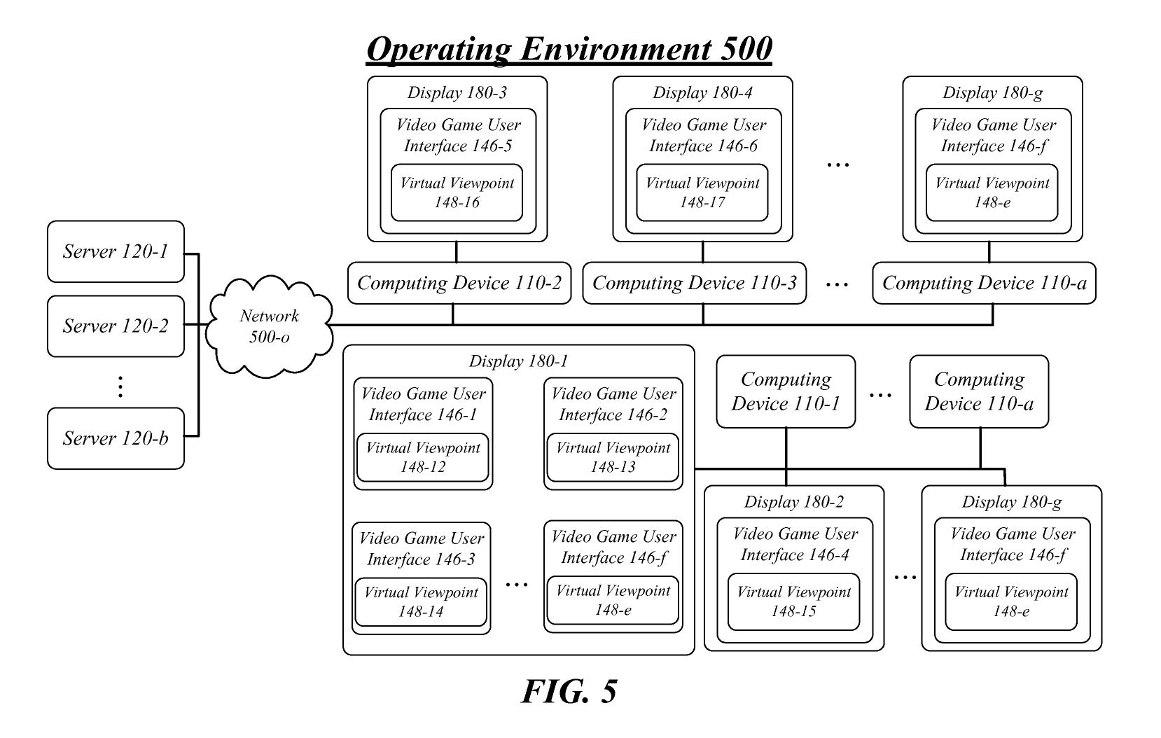

FIG. 5 illustrates an embodiment of an operating environment 500 for the virtual viewpoint management system 100. More particularly, the operating environment 500 may illustrate an arrangement of multiple computing devices 110-a operating a video game application 142. For example, the operating environment 500 may be an arrangement utilized for a e-sports event.

According to the example embodiment provided in FIG. 5, multiple servers 120-1, 120-2, 120-b may be in communication with a plurality of computing devices 110-1, 110-2, 110-3, 110-a through a network 500-o. The computing devices 110-2, 110-3 may be dedicated to live game play, while computing device 110-1 may be dedicated to managing virtual viewpoints 148-12, 148-13, 148-14, 148-15, for example, presented to spectators at the e-sporting event. Each computing device 110-2, 110-3 may have a dedicated display 180-3, 180-4 for displaying a video game user interface 146-5, 146-6 having virtual viewpoints 148-16, 148-17. For instance, the video game application 142 for the e-sports event may be a FPS application such that the virtual viewpoints 148-16, 148-17 are configured as first-person virtual viewpoints 148-e, which is most conducive to this type of game play. The computing device 110-1 may be coupled to more than one display 180-1, 180-2, 180-3 arranged to provide spectators with multiple virtual viewpoints 148-12, 148-13, 148-14, 148-15. During live game play, multiple virtual viewpoints 148-12, 148-13, 148-14, 148-15 may be presented to users for the live game action of users playing on computing devices 110-2, 110-3. In addition, the virtual viewpoints 148-12, 148-13, 148-15, 148-16, 148-17 may be made available over a network 500-o, such as the Internet, for viewing through one or more applications, such as a web browser or a thin client application.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

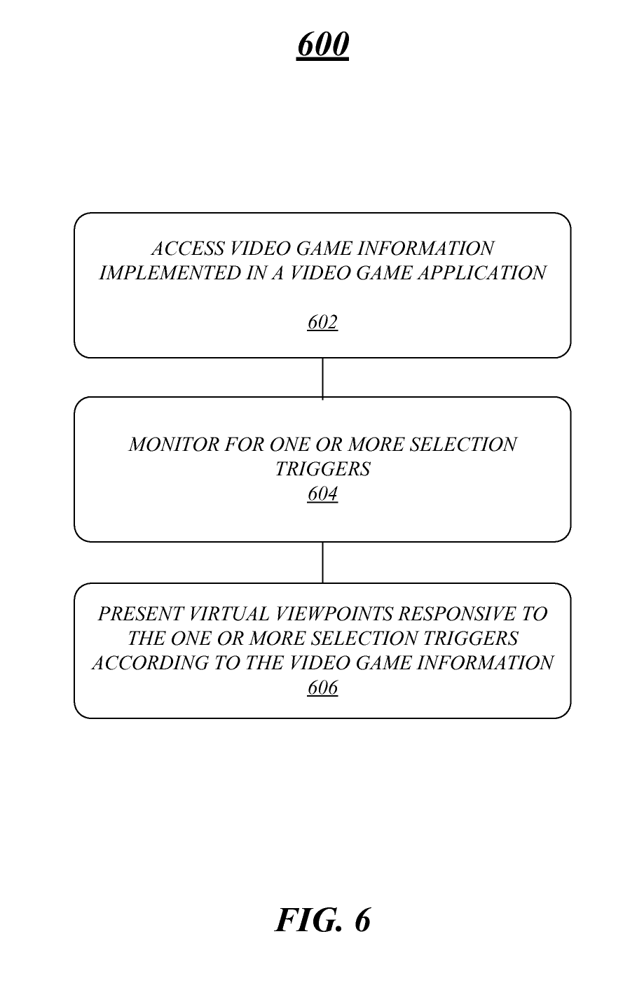

FIG. 6 illustrates one embodiment of a logic flow 600. The logic flow 600 may be representative of some or all of the operations executed by one or more embodiments described herein. For example, the logic flow 600 may illustrate operations performed by the virtual viewpoint management system 100.

In the illustrated embodiment shown in FIG. 6, the logic flow 600 may access video game information implemented in a video game application at block 602. For example, the video game interface component 210-1 may interface with a video game application 142, operating on a computing device 110-a or a server 120-b. The video game interface component 210-1 may access video game information 144-d associated with the video game application 142.

The logic flow 600 may monitor for selection triggers at block 604. For example, the selection trigger monitoring component 210-2 may monitor computing devices 110-a, server 120-b, and the video game application 142 for one or more selection triggers 172-j. The selection triggers 172-j may be configured in the virtual viewpoint application 140. For example, a selection trigger 172-j may be configured wherein a specific game event (e.g., an explosion) invokes one or more virtual viewpoints (e.g., a top-down perspective of the explosion). The occurrence of a selection trigger 172-j may be communicated to other components of the virtual viewpoint application, such as the virtual viewpoint component 210-3.

The logic flow 600 may present virtual viewpoints responsive to the one or more selection triggers according to the video game information 606. For example, the virtual viewpoint component 210-3 may receive a selection trigger 172-j and may access the virtual viewpoints 148-e associated with the selection trigger 172-j. The virtual viewpoint component 210-3 may implement the presentation of the virtual viewpoints 148-e based on the video game information 144-d obtained by the video game information component 210-1, for example, via a virtual camera 170-i.

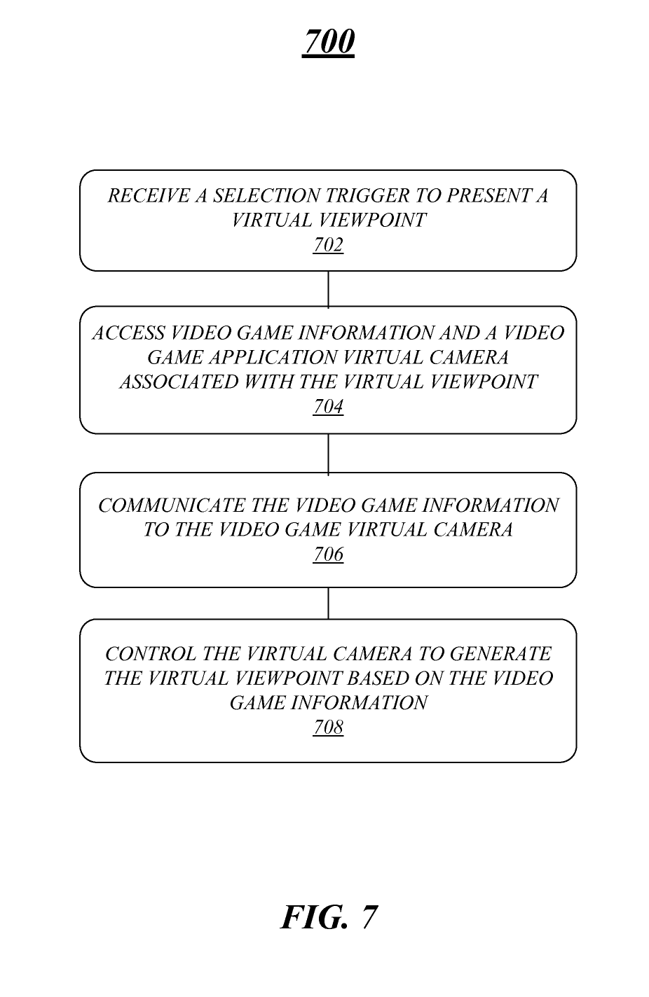

FIG. 7 illustrates one embodiment of a logic flow 700. The logic flow 700 may be representative of some or all of the operations executed by one or more embodiments described herein. For example, the logic flow 700 may illustrate operations performed by the virtual viewpoint management system 100.

In the illustrated embodiment shown in FIG. 7, the logic flow 700 may receive a selection trigger to present a virtual viewpoint at block 702. For example, a selection trigger 172-j may be received by the virtual viewpoint application 140 through the selection trigger monitoring component 210-2. The selection trigger 172-j may be a game event or a manual selection.

The logic flow 700 may access video game information and a video game application virtual camera associated with the virtual viewpoint at block 704. For example, responsive to detecting a selection trigger 172-j through the selection trigger monitoring component 210-2, the virtual viewpoint application 140 may invoke the video game interface component 210-1 to access video game information 144-d. The virtual viewpoint application 140 may access and, therefore, utilize virtual cameras 170-i operating within the video game application 142.

The logic flow 700 may communicate the video game information to the video game virtual camera in block 706. For example, the virtual viewpoint component 210-3 may interface with the video game application 142 so that the virtual viewpoint component 210-3 may utilize virtual cameras 170-i operating therein. In one embodiment, the interface may be comprised of an API or other such programming code compatible with the video game application 142 for accessing components of the video game application 142. The virtual viewpoint component 210-3 may utilize the interface to communicate video game information 144-d to the virtual camera 170-i that may be utilized to generate the virtual viewpoints 148-e invoked by the selection trigger 172-j.

The logic flow 700 may control the virtual camera to generate the virtual viewpoint based on the video game information at block 708. For instance, the virtual viewpoint component 210-3 may control one or more virtual cameras 170-i operating in the video game application 142 so that the one or more virtual cameras 170-i may operate to display the virtual viewpoints 148-e associated with the selection triggers 172-j detected by the selection trigger monitoring component 210-2. In this manner, the virtual viewpoint component 210-3 may activate the virtual cameras 170-i and control them to provide a virtual viewpoint 148-e based on the supplied video game information 144-d.

It may be appreciated that the virtual viewpoint component 210-3 may control any number of virtual cameras 170-i to generate any number of virtual viewpoints 148-e as desired for a given implementation. For instance, the virtual viewpoint component 210-3 may control a single virtual camera 170-1 to generate a single virtual viewpoint 148-1. In another example, the virtual viewpoint component 210-3 may control a single virtual camera 170-1 to generate a multiple virtual viewpoints 148-1, 148-2. In yet another example, the virtual viewpoint component 210-3 may control multiple virtual cameras 170-1, 170-2 to generate a single virtual viewpoint 148-3. In still another example, the virtual viewpoint component 210-3 may control multiple virtual cameras 170-1, 170-2 to generate a multiple virtual viewpoints 148-4, 148-5. The embodiments are not limited in this context.

Furthermore, in some embodiments, the virtual viewpoint component 210-3 may control multiple virtual cameras 170-1 to generate combined virtual viewpoints 148-e. For instance, the virtual viewpoint component 210-3 may control multiple virtual cameras 170-1, 170-2 to generate multiple virtual viewpoints 148-4, 148-5. In addition, the virtual viewpoint component 210-3 may utilize any of various known multimedia editing techniques to combine the virtual viewpoints 148-4, 148-5 into a single virtual viewpoint 148-6. For instance, if the virtual camera 170-1 creates a virtual viewpoint 148-4 with a scene or perspective of a first character on one side of a wall, and if the virtual camera 170-2 creates a virtual viewpoint 148-5 of a second character on the other side of the wall, the virtual viewpoint component 210-3 may merge the two virtual viewpoints 148-4, 148-5 so that the virtual viewpoint 148-6 simultaneously shows both characters on both sides of the wall. In some instances, the virtual viewpoint component 210-3 may control multiple virtual cameras 170-1 to generate combined virtual viewpoints 148-e that are displaced in time, such as overlays of different characters within a same virtual environment performing a same or similar task (e.g., shooting a target, jumping an obstacle, throwing a pass, etc.) at different times to evaluate performance of each character while performing the task. The embodiments are not limited in this context.

FIG. 8 illustrates an embodiment of an exemplary computing architecture 800 suitable for implementing various embodiments as previously described. In one embodiment, the computing architecture 800 may comprise or be implemented as part of computing devices 110-a or servers 120-b.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, such as those described with reference to the processor circuit 130 shown in FIG. 1.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

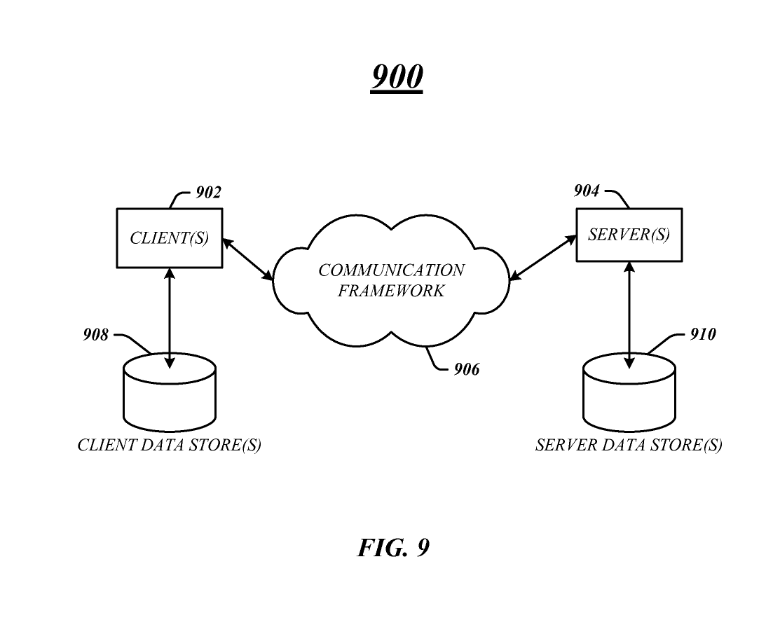

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the computing device 110-a and the servers 904 may implement the servers 120-b. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

The various elements of the virtual viewpoint management system 100 as previously described with reference to FIGS. 1-9 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
accessing video game information implemented in a video game application operating on a computing device;
monitoring for one or more selection triggers; and
presenting one or more virtual viewpoints on one or more display devices responsive to the one or more selection triggers, the one or more virtual viewpoints being presented according to the video game information during live game play of the video game application in substantially real-time.

2. The method of claim 1, wherein video game information comprises at least one of:
event information;
virtual environment information;
player object information; and
virtual camera information.

3. The method of claim 1, wherein the one or more selection triggers comprise at least one of:
manual selection of a location within a virtual environment implemented by the video game application;
manual selection of a virtual game object within the virtual environment;
detection of event activity within the virtual environment indicated by the video game information; and
obstruction of a view of one or more player objects implemented by the video game application.

4. The method of claim 3, wherein the event activity comprises at least one of a heat map indicating one or more areas of high activity within the virtual environment and one or more player object actions.

5. The method of claim 4, wherein the one or more player object actions comprise at least one of:
interaction between the one or more player objects;
interaction with one or more game elements by the one or more player objects;
changes to one or more player object characteristics;
transition to a new level; and
transition to a specified area in the virtual environment.

6. The method of claim 1, wherein the one or more virtual viewpoints comprise at least one of:
a first-person perspective;
a second-person perspective;
a third-person perspective;
a player object top-down perspective;
a virtual environment top-down perspective; and
a virtual environment activity top-down perspective.

7. The method of claim 1, wherein presenting one or more virtual viewpoints comprises invoking one or more virtual cameras implemented by the video game application.

8. The method of claim 1, wherein presenting one or more virtual viewpoints comprises simultaneously presenting a plurality of virtual viewpoints on the one or more display devices.

9. The method of claim 1, wherein the one or more virtual viewpoints are configured to present multiple virtual viewpoints of a live gameplay event.

10. An apparatus, comprising:
a transceiver;
a processor circuit coupled to the transceiver; and
a memory unit coupled to the processor circuit, the memory unit to store a virtual viewpoint management application operative on the processor circuit to selectively present virtual viewpoints of a video game application, the virtual viewpoint management application comprising:
a video game interface component operative to access video game information implemented in the video game application;
a selection trigger monitoring component operative to monitor for one or more selection triggers; and
a virtual viewpoint component operative to present one or more virtual viewpoints on one or more display devices responsive to the one or more selection triggers, the one or more virtual viewpoints being presented according to the video game information during live game play of the video game application in substantially real-time.

11. The apparatus of claim 10, the video game interface component operative to access video game information comprising at least one of:
event information;
virtual environment information;
player object information; and
virtual camera information.

12. The apparatus of claim 10, the selection trigger monitoring component operative to monitor for one or more selection triggers comprising at least one of:
manual selection of a location within a virtual environment implemented by the video game application;
manual selection of a virtual game object within the virtual environment;
detection of event activity within the virtual environment indicated by the video game information; and
obstruction of a view of one or more player objects implemented by the video game application.

13. The apparatus of claim 12, the event activity comprising at least one of a heat map indicating one or more areas of high activity within the virtual environment and one or more player object actions.

14. The apparatus of claim 13, the one or more player object actions comprising at least one of:
interaction between the one or more player objects;
interaction with one or more game elements by the one or more player objects;
changes to one or more player object characteristics;
transition to a new level; and
transition to a specified area in the virtual environment.

15. The apparatus of claim 10, the virtual viewpoint component operative to present one or more virtual viewpoints comprising at least one of:
a first-person perspective;
a second-person perspective;
a third-person perspective;
a top-down perspective;
a player object overhead view;
a virtual environment overhead view; and
a virtual environment activity overhead view.

16. The apparatus of claim 10, the virtual viewpoint component operative to present one or more virtual viewpoints via invoking one or more virtual cameras implemented by the video game application.

17. The apparatus of claim 10, the virtual viewpoint component operative to simultaneously present a plurality of virtual viewpoints on the one or more display devices.

18. The apparatus of claim 10, the virtual viewpoint component operative to present multiple virtual viewpoints of a live gameplay event.

19. At least one machine-readable storage medium comprising a plurality of instructions that in response to being executed on a computing device, cause the computing device to:
access video game information implemented in a video game application;
monitor for one or more selection triggers; and
present one or more virtual viewpoints on one or more display devices responsive to the one or more selection triggers, the one or more virtual viewpoints being presented according to the video game information during live game play of the video game application in substantially real-time.

20. The computer-readable storage medium of claim 17, comprising instructions that when executed cause the computing device to simultaneously present a plurality of virtual viewpoints on the one or more display devices.
